(19) United States
(12) Patent Application Publication
(10) Pub. No.: US 2025/0067568 A1
(43) Pub. Date: Feb. 27, 2025

(54) VEHICLE NAVIGATION USING OBSTACLE AVOIDANCE BASED ON USER PREFERENCE

(71) Applicant: INTERNATIONAL BUSINESS MACHINES CORPORATION, Armonk, NY (US)

(72) Inventors: Uri Kartoun, Cambridge, MA (US); Kenney Ng, Arlington, MA (US); Jeremy R. Fox, Georgetown, TX (US); Fang Lu, Billerica, MA (US)

(21) Appl. No.: 18/452,773

(22) Filed: Aug. 21, 2023

(51) Int. Cl. G01C 21/34

(52) U.S. Cl. CPC G01C 21/3484; G01C 21/3461

(57) ABSTRACT

Alternative route determination includes identifying an obstacle along an initial driving route to a destination specified by a user, presenting, on a user interface for the user, details of the obstacle, prompting the user, on the user interface, to input, via the user interface, a rating for the obstacle that indicates the user's tolerance to traversing the obstacle while driving, receiving from the user the rating for the obstacle, the rating indicating the user's tolerance to traversing the obstacle while driving, wherein the rating indicates that the obstacle is to be avoided, and recalculating the initial driving route to the destination to provide an alternative driving route to the destination, where the alternative route avoids the obstacle.

### BACKGROUND

Individuals can feel uncomfortable driving a vehicle in varying situations, for instance when traversing certain roadway features, conditions, structures, or the like (referred to herein as obstacles) and under varying contexts. Example obstacles include, but are not limited to, mountain areas, cliffs or cliff-side roads, tunnels, and bridges. When driving a vehicle to traverse obstacles of varying features, drivers might experience negative health impacts like symptoms of anxiety or fear. The magnitude of the impact can vary by individual, and even the same individual might experience different levels of impact depending on the time of day, amount of traffic, or other contexts in which the driver encounters the obstacle. The anxiety that the driver experiences could impact the driver's ability to traverse the obstacle safely and successfully.

### SUMMARY

Shortcomings of the prior art are overcome and additional advantages are provided through the provision of a computer-implemented method. The method identifies an obstacle along an initial driving route to a destination specified by a user. The method also presents, on a user interface for the user, details of the obstacle. The method additionally prompts the user, on the user interface, to input, via the user interface, a rating for the obstacle that indicates the user's tolerance to traversing the obstacle while driving. The method receives from the user the rating for the obstacle. The rating indicates the user's tolerance to traversing the obstacle while driving. The rating indicates that the obstacle is to be avoided. The method additionally recalculates the initial driving route to the destination to provide an alternative driving route to the destination, and the alternative route avoids the obstacle.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual representation of alternative route determination for obstacle avoidance, in accordance with aspects described herein;

FIGS. 3A-3D depict further details of an example navigation module and sub-modules thereof to incorporate and/or use aspects described herein; and

FIGS. 4A-4C depict example processes for automated alternative route determination, in accordance with aspects described herein.

### DETAILED DESCRIPTION

Different individuals have different tolerances to traversing, i.e., traveling over/in, different obstacles and in different contexts. Some drivers might experience fear while driving over bridges that are taller than some threshold height. Other drivers might have a higher tolerance for bridge travel, even high bridges, as long as the time taken to traverse the bridge is relatively short (say, less than one minute). Travel context, such as time of day might factor in as well; a driver might be unable to drive over a given bridge during the day but might tolerate the same bridge if driving over it at night when it is dark out and the height of the bridge is less apparent. In short, both (i) features of the obstacles and (ii) the travel context in which the obstacles are encountered for traversal can factor into an individual's tolerance for traversing the obstacle while driving.

Described herein are approaches for vehicle navigation using obstacle avoidance based on user preference. For instance, aspects provide alternative route determination for obstacle avoidance based on a user's individual tolerances. A user's tolerance to traversing varying obstacles while driving can be based on any of various fears with which the user is afflicted. Acrophobia, for instance, refers to a fear of heights or high places, and gephyrophobia refers to a fear of bridges and tunnels. A software component can assist a driver/user desiring to avoid certain obstacles when driving from one location to a destination location. The software could identify alternative route(s) for the driver to take in order to deliver a more pleasant travel experience.

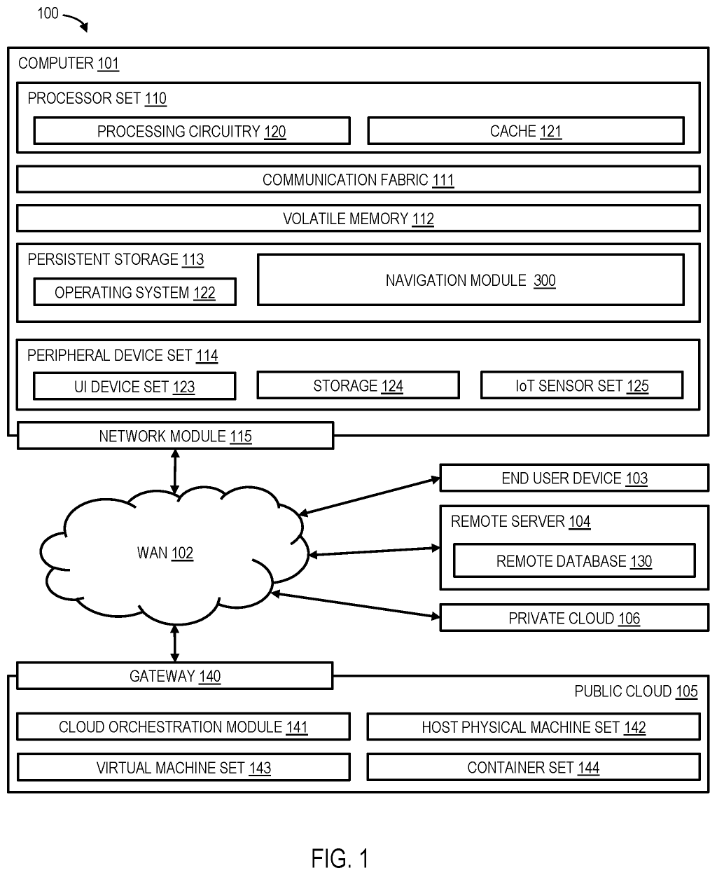

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing aspects of the present disclosure, such as code of navigation module 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 300 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 300 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Aspects described herein can identify a personalized route for a driver considering obstacle ratings provided by the driver, features/details of obstacles, and/or travel contexts such as traffic, weather, and time of day properties, as examples.

Consider the following situation to illustrate capabilities of the present disclosure. A driver/user desires to drive from the user's current location—Cambridge, Massachusetts—to Princeton, New Jersey. The driver opens a navigation application, for instance one installed on the user's mobile device or in the user's vehicle, and inputs a destination address in Princeton, New Jersey. The navigation application then calculates an initial driving route from the current location to the destination address. For instance, the application calculates the route having the shortest travel time as the initial driving route. The application also identifies one or more obstacles along that initial driving route to the destination and determines details of the obstacle(s). The application then solicits input from the user as to the user's tolerance to traversing each such obstacle, for instance by presenting on a user interface (such as display of the mobile device or vehicle) details of the obstacles. The details of an obstacle could be presented on the interface in any desired form—image(s), drop-down boxes, radio selections, free text descriptions etc. In particular examples, at least an image of the obstacle is used because images can easily and quickly convey varying details of the obstacle to the user. A non-limiting list of example obstacle details are features like location, height, length, slope (for instance how steep a bridge or ramp is), and number of driving lanes of the obstacle. In addition, a travel context in which the obstacle will be encountered on the route can also be indicated. For instance, projected traffic volume, weather, and/or time of day when the obstacle is expected to be encountered along the route can be indicated, since travel context can be relevant to whether the user can tolerate traversing an obstacle while driving.

The application also prompts the user, on the user interface, to input (for instance via selection of element(s) on the interface) a rating for the obstacle, the rating being an indication of the user's tolerance to traversing the obstacle while driving. A rating selection could be a binary selection, for instance a selection between Allow (or Tolerate) and Avoid, to indicate that the navigation should allow, or avoid, respectively, the obstacle on the travel route. Alternatively, ratings could be selected between any number of discrete selections or selected on a continuous spectrum, for instance via a slider element ranging between two ratings. In specific examples, the rating scale is based on a level of fear, anxiety, nervousness, or the like that the user expects to experience if needing to traverse the obstacle. Thus, the prompting could prompt the user to select between (i) an option of avoiding traversal of the obstacle and (ii) an option of tolerating traversal of the obstacle. Alternatively, the prompting could prompt the user to select between varying options on a tolerance rating scale.

In response to prompting the user and the user providing a rating, the application receives the rating for the obstacle indicating the user's tolerance to traversing the obstacle while driving.

As noted, there could be multiple obstacles along the initial driving route, and therefore presenting the obstacle details could present details of the multiple obstacles, prompting could prompt the user to input a respective rating for each of the multiple obstacles, and the application can receive a respective rating for each of the multiple obstacles for which it prompted user input.

Continuing with the example above of the user traveling to Princeton, New Jersey, assume that there were 4 bridges and 2 tunnels identified and expected to be encountered along the initial route. The application can present to the user a picture of each bridge and tunnel expected to be encountered and prompt the user for a user rating of each obstacle, for example to indicate either to avoid or to allow traversal of the obstacle along the travel route to the destination.

In situations where multiple obstacles are identified along the initial driving route, an option is to present the multiple obstacles and details thereof in a ranked order. The ranking of the order could be based on predictions as to the user's tolerance of each obstacle, for instance a prediction about the user's least-to-most tolerated obstacles in the list. Alternatively, the ranking of the order could be based on a composite tolerance rating that is composited across a collection of other users. The composite tolerance rating of each obstacle could be a composite of crowdsourced ratings from other users, or any other composite rating. In examples, the ranked order in which the obstacles are presented orders the obstacles from least-to-most tolerated, in other words most avoided to least avoided. Ranking in order of progressively higher tolerance might allow the application to infer tolerated obstacles for a user once that user has worked sufficiently far down the list that the user has reached obstacles that the user indicates as being tolerated. Obstacles that are ranked as being more tolerated across the collection of crowdsourced ratings might be assumed to be more tolerable for this user too.

In identifying the obstacles and their details, the application could also begin considering alternative routes (e.g., around obstacles) which could inform deviations from the initial driving route. Example deviations are changed (e.g., increased) travel time if avoiding a given obstacle and/or increased or reduced tolls (or a requirement for a transponder) if avoiding the obstacle. It might be determined, optionally also considering the specific travel context such as traffic conditions, that navigating around a given tunnel is expected to add 45 minutes or more travel time, or increase toll amount by $15. The application could therefore indicate to the user one or more such deviations between the initial driving route and an alternative driving route that avoids the obstacle, like a difference in estimated time of arrival to the destination as between the initial driving route and an alternative driving route, and/or a difference in toll fees as between the initial driving route and the alternative driving route.

Assuming the user selects a rating for one (or more) of the obstacle(s) that indicates the one or more obstacles is/are to be avoided, this user feedback triggers the navigation engine to recalculate the initial driving route to the destination and provide an alternative driving route to the destination, where the alternative route avoids the obstacle(s) indicated for avoidance. The application could notify the driver/user that the alternative route avoids obstacle(s), and which obstacles are avoided. The application could send reminder/notifications to the driver before taking the alternative route and/or in real time while driving along the alternative route as the user navigates around the obstacle.

Additionally or alternatively, once the alternative driving route is determined, then any deviations from the initial driving route could be alerted to the user at that point. Deviations due to obstacle avoidance for multiple obstacles along the route could be aggregated together to present, e.g., an overall increase in travel time or change in toll amount. This provides the user a chance to consider whether the alternative driving route is acceptable.

Operating as above for other destinations to which the user navigates, a system could learn the user's various obstacle tolerance selections/preferences, including (i) obstacle features such as (but not limited to) height, length, duration to traverse, slope, and/or number of driving lanes of one or more obstacles, and (ii) travel contexts such as (but not limited to) those pertaining to traffic volume, weather, and time of day under which obstacles are encountered. The preferences could be indicative of tolerance and/or avoidance of obstacles having those features and/or being encountered under those travel contexts. Over time, these selections can be aggregated to provide training data specific to the user. Machine learning can train a model for the user that can be used and applied to later navigation requests of the user to automatically classify obstacles as to avoidance or tolerance for traversal along driving routes, and thereby inform which obstacles are to be avoided.

In addition to gathering user ratings for actual obstacles along a specific route, aspects could optionally prompt the user for ratings pertaining to modified travel contexts and/or obstacle features of those obstacles or any obstacle more generally. For example, the application could prompt the user as to the user's tolerance to driving at different time(s) of day, in different lighting conditions or traffic volumes, as well as the user's tolerance to other/alternative obstacle features such as height, length, number of lanes, and other characteristics or details about obstacles. In a specific example using the navigation scenario above, the user being navigated to Princeton ranks a bridge that is 40 feet above the ground as being tolerated, meaning avoidance is not necessary. The application could, at that time or at another time, ask the user whether that bridge (or more generally any bridge) would be tolerated at a height of 50 feet above the ground. The application could present any modification(s) to obstacle features or travel context and inquire with the user as to whether the resulting features/contexts would be tolerated. In this manner, various obstacle features and travel contexts can be presented to the user, either alone or in combination with each other, and the user's ratings can be gathered and aggregated to build more data points as obstacle tolerance selections.

Thus, a process could present to the user various other obstacle features and/or other travel contexts, prompt the user to indicate the user's tolerance (ratings) to (i) traversing obstacles having those other obstacle features and/or (ii) traversing obstacles in those other travel contexts, receive tolerance ratings from the user, and use those to build other obstacle tolerance selections. Notably, such prompting could be done at any time, and need not necessarily be done in the context of an actual trip or with specific reference to actual obstacles.

Aspects can adaptively learn users' levels and extents of avoidance/tolerance and automatically approve or disapprove the inclusion of certain obstacles identified along routes when navigating the user in the future. If the user above travels to California, aspects can classify additional obstacles (e.g., those not already ranked by the user) to automatically inform that the Golden Gate bridge is to be avoided but to automatically approve the Dumbarton Bridge (as examples) based on learning from the user's prior obstacle tolerance selections. The user can be informed of any automatic avoidance/tolerance determinations by the application, and the user could provide overrides if desired.

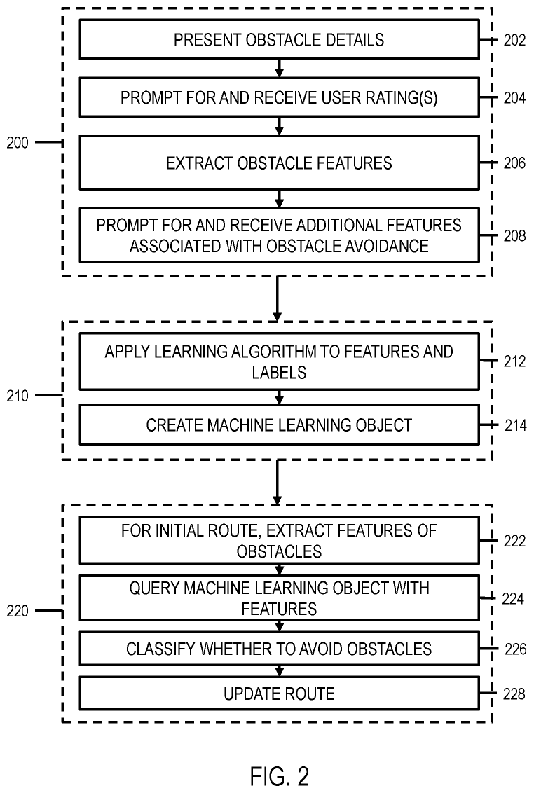

FIG. 2 depicts an example conceptual representation of alternative route determination for obstacle avoidance, in accordance with aspects described herein. Aspects of FIG. 2 could be performed by one or more processes as software executing on one or more computer systems, for instance.

One aspect is obstacle tolerance selection 200 that obtains obstacle tolerance selections either in connection with, or separate from, an actual request to navigate to a real destination. In this aspect, the process presents (202) obstacle details to a user, for instance presents images or other details of real or hypothetical obstacles, and prompts (204) for, and receives, user ratings for such obstacles. Example user ratings are “tolerated” and “not tolerated”. The process extracts (206) obstacle features of the detailed obstacles. The features may be gleaned from metadata about the obstacle, for instance metadata assembled from public or other sources. For a bridge type of obstacle, the metadata might indicate a height, a length, a number of lanes, and an obstacle type (e.g., bridge), for instance. This aspect also prompts (208) for, and receives, additional features associated with obstacle avoidance and/or tolerance, for instance by asking the user about avoiding other/additional obstacle features, such instance bridges above 50 feet, or tunnels longer that a quarter mile, as examples. This aspect can also identify travel context under which the obstacles/features are expected to be encountered. The extracted obstacle features and relevant travel contextual features can be stored in a training database as obstacle tolerance selections.

Another aspect is model learning 210 that applies (212) a supervised machine learning algorithm to the obstacle features (heights, lengths, number of lanes, locations, obstacle types, etc.) and contexts, and their corresponding labels (avoid, tolerate, rating 2 of 5, etc.), to create (214) a machine learning object, such as a trained model. In this aspect, the model is built from training data that may be aggregated obstacle tolerance selections in a training database. The training data need not necessarily be associated with a specific obstacle. For instance, a user's preference may be to never drive over any obstacle higher than 100 feet above ground level. The process builds and trains the learning model using the training data to learn tolerances of the user as to traversing obstacles of varying obstacle features and in varying travel contexts. In this regard, the model may be user-specific, having been trained from the user's individual preferences.

The machine learning object could, in some embodiments, be or comprise a data structure that can later be applied and/or queried, for instance using obstacle and/or contextual features as parameters. This can be useful when the user is to be navigated to other destinations. Thus, another aspect of FIG. 2 is a navigating aspect 220 that is used when a user selects a destination to which the user wants to be navigated and a learning model specific to the user is available. The application can determine an initial route, for instance the route that has the fastest driving time. For this initial route, the process identifies obstacle(s) along the initial driving route to the destination specified by the user, extracts (222) features of the obstacle(s), and identifies travel context(s) under which the user is expected to encounter the obstacle(s) based on the initial driving route. The process applies the learning model using the identified features of the obstacle(s) and travel context(s), for instance by querying (224) the machine learning object, and this classifies (226), for each obstacle, whether to avoid the obstacle. In situations where at least one obstacle along the initial route is to be avoided, the obstacle is identified and the route can be updated (228) accordingly, i.e., to avoid that obstacle. For instance, the application recalculates the initial driving route to the destination to provide an alternative driving route that avoids each obstacle along the initial driving route that was classified for avoidance. The alternative route could be presented to the user for confirmation/acceptance to begin navigating.

Thus, in accordance with aspects described herein, methods are provided to calculate personalized driving routes for users. An example such method has the user specify a location of an origin (starting point) and a destination. The method identifies bridges, tunnels, and other obstacles classified as such (for instance as maintained in public or private databases and/or determined based on threshold details such as height, location, etc.), introduces to the user an image of each obstacle to convey the nature of the obstacle to the user, and asks the user to label each image (or other details set for each obstacle) as “avoid” or “tolerated”. The method also calculates a delay time (an amount of time added to the estimated time of arrival to the destination) for alternative route(s) around obstacles to be avoided, and lets the user approve or reject change(s) from the route. Optionally, for each image/obstacle to be ranked by the user, the method can prompt for additional information from the user, such as tolerance to traverse the obstacle under different timing or lighting conditions (e.g., at night as opposed to during daylight) and different traffic/delay conditions (e.g., light traffic when traversal will move faster than in heavy traffic when delays may be expected). It can also prompt about the user's tolerance relative to other criteria such as bridge heights, lengths, number of lanes, and any other obstacle features. The method dynamically recalculates the route based on the user's feedback as to obstacle features and the relevant travel contexts involved. Meanwhile, user preferences are stored as training data for model building to help navigating to future destinations. When the user enters a new destination, the method can propose to automatically apply what was learned to avoid/tolerate obstacles that are identified along a route to the new destination.

Aspects described herein, if integrated into existing navigation systems, can ease the driving experiences for various individuals. It could also provide improvements in overall traffic flow, particularly around obstacles, because drivers tend to drive slower when traversing obstacles about which they are nervous or uncomfortable. Navigation service applications could benefit from aspects described herein. In a particular embodiment, a navigation application includes a toggle that enables functionality described herein for learning and automatically determining obstacles to avoid or traverse to be turned on or off.

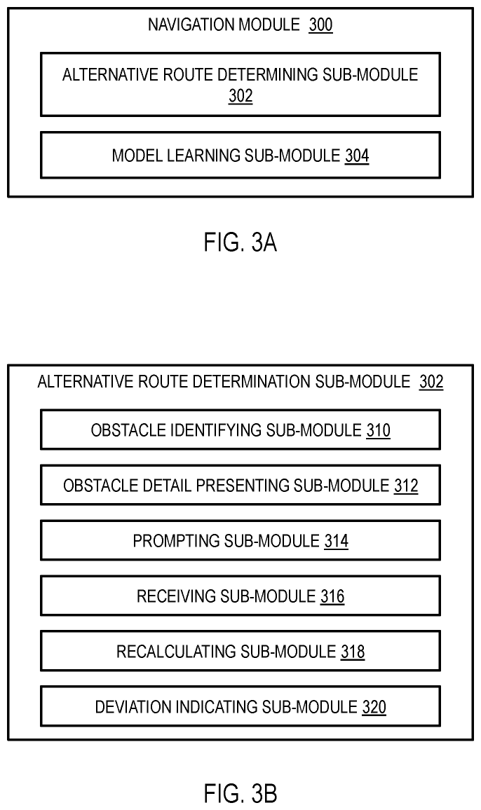

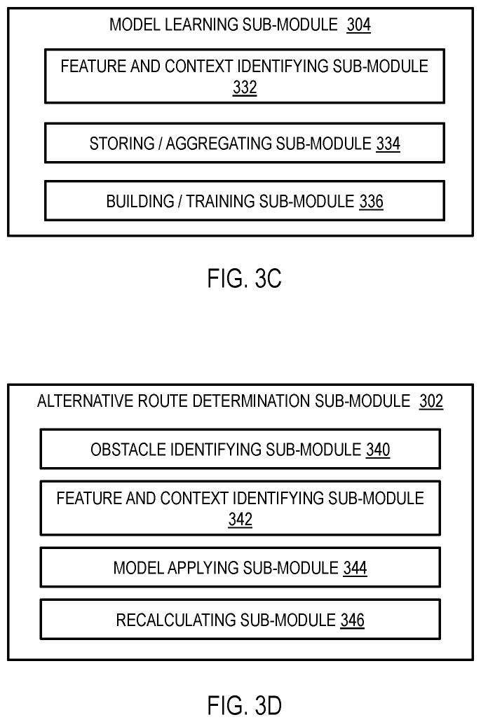

FIGS. 3A-3D depict further details of an example navigation module and sub-modules thereof to incorporate and/or use aspects described herein. Modules/sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuity thereof, such as computer(s) 101, EUD 103, server 104, or computers of cloud 105/106 of FIG. 1, as examples.

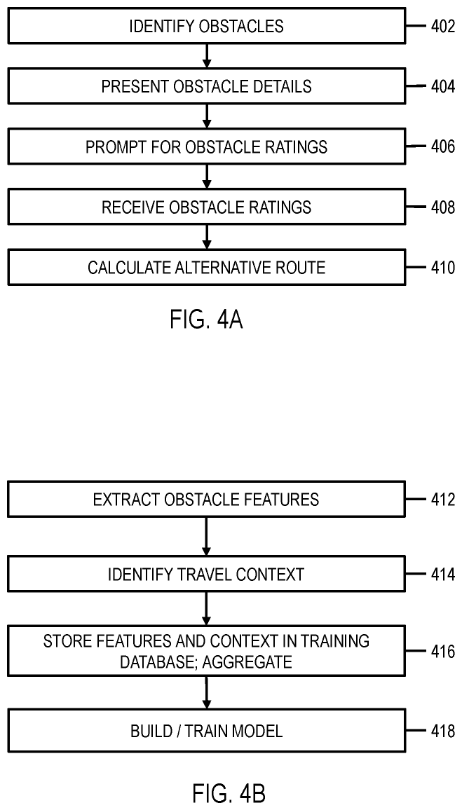

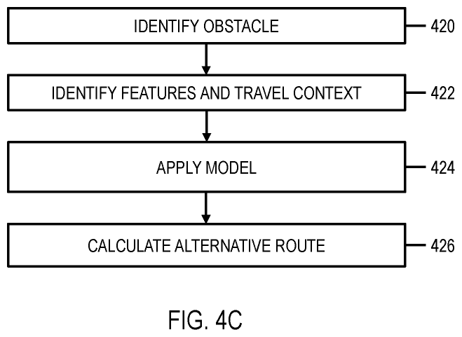

Initially referring to FIG. 3A, further details of an example navigation module (e.g., navigation module 300 of FIG. 1) to incorporate and/or use aspects described herein are shown. Navigation module 300 includes, in one example, various sub-modules to be used to perform alternative route determination based on machine learning and tolerance-based obstacle avoidance. Here, the navigation module 300 includes an alternative route determining sub-module 302 and a model learning sub-module 304. Aspects of these sub-modules are described also with reference to FIGS. 4A-4C, which depict example processes for automated alternative route determination, in accordance with aspects described herein. Such processes may be executed, in one or more examples, by a processor or processing circuitry of one or more computers/computer systems, such as those described herein, and more specifically those described with reference to FIG. 1. In one example, code or instructions implementing the process(es) of FIGS. 4A-4C are part of a module, such as module 300. In other examples, the code may be included in one or more modules and/or in one or more sub-modules of the one or more modules. Various options are available.

Referring collectively to the alternative route determination sub-module 302 of FIG. 3B and the process FIG. 4A for automated alternative route determination, the alternative route determination sub-module 302 includes an obstacle identifying sub-module 310 for identifying (FIG. 4A, 402) an obstacle along an initial driving route to a destination specified by a user. In examples, the identifying (402) could identify multiple such obstacles along the initial driving route. Example obstacles include, but are not limited to, bridges, tunnels, cliff-side roads, and mountains. The alternative route determination sub-module 302 also includes an obstacle detail presenting sub-module 312 for presenting (FIG. 4A, 404), on a user interface for the user, details of the obstacle. In examples where multiple obstacles are identified at 402, the presenting presents the details of each obstacle identified. Presenting the details of an obstacle can include presenting an image of the obstacle to the user on the user interface, as just one example. In a multiple obstacle situation, the presentation of details of the multiple obstacles could indicate the multiple obstacles to the user in a ranked order. The ranked order could be based on a composite tolerance rating, and order the multiple obstacles from least tolerated to least avoided.

The alternative route determination sub-module 302 also includes a prompting sub-module 314 for prompting (FIG. 4A, 406) the user, on the user interface, to input, via the user interface, a rating for the obstacle that indicates the user's tolerance to traversing the obstacle while driving. In a multiple obstacle situation, the prompting could prompt the user to input a respective rating for each of the multiple obstacles. In examples, the prompting prompts the user to select between an option of avoiding traversal of the obstacle and an option of tolerating traversal of the obstacle. In other examples, the prompting prompts the user to select between options on a tolerance rating scale.

The alternative route determination sub-module 302 also includes a receiving sub-module 316 for receiving (FIG. 4A, 408) from the user the rating for the obstacle. In a multiple obstacle situation, the receiving could receive a respective rating for each of the multiple obstacles. A rating for an obstacle indicates the user's tolerance to traversing the obstacle while driving. The rating could indicate, either directly or indirectly for instance based on a threshold-based approach or other translation of a rating to an ‘avoid’ or tolerate ‘indication’, that the obstacle is to be avoided or that the obstacle is tolerated and need not be avoided, and therefore the rating ultimately is to result in an ‘avoid’ or ‘allow’ designation.

The alternative route determination sub-module 302 also includes a recalculating sub-module 318 for, in situations where an obstacle or obstacles is/are rated for avoiding, recalculating (FIG. 4A, 410) the initial driving route to the destination to provide an alternative driving route to the destination, where the alternative route avoids the obstacle.

The alternative route determination sub-module 302 also includes a deviation indicating sub-module 320 for indicating to the user one or more deviations between the initial driving route and the alternative driving route. Deviations could include difference(s) in estimated time of arrival to the destination as between the initial driving route and an alternative driving route, and/or difference(s) in toll fees as between the initial driving route and an alternative driving route, for instance. Deviations could be determined and presented on the fly when presenting obstacle details and soliciting user ratings, for instance if at that point in time potential alternative route(s) and delays associated therewith can be determined. Additionally or alternatively, deviations could be ascertained after the user has input the user's obstacle ratings and an alternative route has been calculated to avoid all desired obstacles of the initial route.

As part of prompting to user to rate actual obstacles along an initial route, a process could solicit additional obstacle tolerations selections by presenting, to the user, other obstacle features and other travel contexts, prompting the user to indicate the user's tolerance to traversing obstacles that have the other obstacle features and/or traversing obstacles in other travel contexts, and receiving, in response, tolerance ratings from the user that are used to build the other obstacle tolerance selections. Alternatively or additionally, this could be done at times other than when the user is seeking navigation to a given destination, for instance as part of a separate session to prompt for and building training data by build/training sub-module (see below).

Referring collectively to the model learning sub-module 304 of FIG. 3C and the process FIG. 4B for model building/training, the model learning sub-module 304 includes a feature and context identifying sub-module 332. Sub-module 332 is for extracting (412) obstacle features of an obstacle presented. Obstacle features can include height, length, duration to traverse, slope, and/or number of driving lanes, as examples. Sub-module 332 also identifies (414) a travel context under which the user is expected to encounter the obstacle based on a driving route. Travel contexts can encompass any number of properties describing the context of the travel along the route and encountering the obstacle, for instance traffic volume, weather, and time of day under which an obstacle is encountered.

The model learning sub-module 304 also includes a storing/aggregating sub-module 334 for storing (416) the extracted features and the travel context as an obstacle tolerance selection in a training database and aggregating the obstacle tolerance selections with each other to aggregate the user's ratings regarding varying obstacle features and travel contexts to provide training data.

Obstacle tolerance selections could be gathered at any desired time, whether it be within the context of prompting about an initial route and the obstacles identified along that route, or separately. In some examples, a process presents to the user other obstacle features and other travel contexts, prompts the user to indicate the user's tolerance to traversing obstacles that have the other obstacle features and/or traversing obstacles in other travel contexts, and receives, in response, tolerance ratings from the user that are used to build the other obstacle tolerance selections, and this is done during a training session initiated by the user or the application. In some examples, the application might identify features and/or contexts on which additional training data is needed to better inform a proper learning model, and solicit user input as to those features and/or contexts specifically.

The model learning sub-module 304 also includes a building/training sub-module 336 for building and training (418) a learning model, using the training data, to learn tolerances of the user as to traversing obstacles of varying obstacle features and in varying travel contexts.

In addition to the alternative route determination sub-module 302 being used as in the process of FIG. 4A, the sub-module 302 could be used also to apply a learning module that has been built and trained for the user. Thus, FIG. 3D presents additional details of the alternative route determination sub-module 302 of FIG. 3A, with a corresponding process shown in FIG. 4C for automated alternative route determination when a user has selected to navigate to another destination and the learning model is to be used. Sub-modules of FIG. 3D could correspond to the same or different sub-module(s) as those presented in FIG. 3B. Referring collectively to the alternative route determination sub-module 302 of FIG. 3D and the process FIG. 4C for automated alternative route determination, the alternative route determination sub-module 302 includes an obstacle identifying sub-module 340 for identifying (FIG. 4C, 420) one or more obstacles along an initial driving route to the another destination specified by the user, a feature and context identifying sub-module 342 for identifying (FIG. 4C, 422) features of each of the one or more obstacles and travel contexts under which the user is expected to encounter each of the one or more obstacles based on the initial driving route to the another destination, a model applying sub-module 344 for applying (FIG. 4C, 424) the learning model using the identified features of each of the one or more obstacles and travel contexts, where the applying identifies at least one obstacle of the one or more obstacles along the initial driving route to the another destination that is to be avoided, and a recalculating sub-module 346 for recalculating (FIG. 4C, 426) the initial driving route to the another destination to provide an alternative driving route to the another destination, where the alternative route avoids the at least one obstacle along the initial driving route to the another destination. For any obstacle(s) that the model is unable to confidently classify an identified obstacle as either ‘avoid’ or ‘tolerate’, the user could be prompted to rate that obstacle as was discussed above in connection with the process of FIG. 4A to inform the application as to the user's tolerance for those obstacle(s). In this manner, obstacle avoidance could be determined automatically for some obstacles along the route and determined by prompting the user for other obstacles along the route.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
identifying an obstacle along an initial driving route to a destination specified by a user;
presenting, on a user interface for the user, details of the obstacle;
prompting the user, on the user interface, to input, via the user interface, a rating for the obstacle that indicates the user's tolerance to traversing the obstacle while driving;
receiving from the user the rating for the obstacle, the rating indicating the user's tolerance to traversing the obstacle while driving, wherein the rating indicates that the obstacle is to be avoided; and
recalculating the initial driving route to the destination to provide an alternative driving route to the destination, wherein the alternative route avoids the obstacle.

2. The method of claim 1, wherein the prompting prompts the user to select between an option of avoiding traversal of the obstacle and an option of tolerating traversal of the obstacle.

3. The method of claim 1, wherein the prompting prompts the user to select between options on a tolerance rating scale.

4. The method of claim 1, wherein the presenting the details of the obstacle comprises presenting an image of the obstacle to the user on the user interface.

5. The method of claim 1, wherein the identifying identifies multiple obstacles along the initial driving route, wherein the presenting presents details of the multiple obstacles, wherein the prompting prompts the user to input a respective rating for each of the multiple obstacles, and wherein the receiving receives a respective rating for each of the multiple obstacles.

6. The method of claim 5, wherein the presenting details of the multiple obstacles indicates the multiple obstacles to the user in a ranked order based on a composite tolerance rating, the ranked order ordering the multiple obstacles from least tolerated to least avoided.

7. The method of claim 1, wherein the obstacle comprises at least one selected from the group consisting of a bridge, a tunnel, a cliff-side road, and a mountain.

8. The method of claim 1, further comprising indicating to the user one or more deviations between the initial driving route and the alternative driving route, the one or more deviations comprising at least one selected from the group consisting of (i) a difference in estimated time of arrival to the destination as between the initial driving route and the alternative driving route, and (ii) a difference in toll fees as between the initial driving route and the alternative driving route.

9. The method of claim 1, further comprising:
extracting obstacle features of the obstacle;
identifying a travel context under which the user is expected to encounter the obstacle based on the initial driving route;
storing the extracted features and the travel context as an obstacle tolerance selection in a training database;
aggregating the obstacle tolerance selection with other obstacle tolerance selections in the training database, the other obstacle tolerance selections comprising other obstacle features and other travel contexts, wherein the aggregating provides training data; and
building and training a learning model, using the training data, to learn tolerances of the user as to traversing obstacles of varying obstacle features and in varying travel contexts.

10. The method of claim 9, further comprising:
presenting, to the user, the other obstacle features and other travel contexts;
prompting the user to indicate the user's tolerance to at least one selected from the group consisting of (i) traversing obstacles that have the other obstacle features and (ii) traversing obstacles in other travel contexts; and
receiving, in response, tolerance ratings from the user that are used to build the other obstacle tolerance selections.

11. The method of claim 9, wherein the varying obstacle features comprise at least one of the group consisting of: height, length, duration to traverse, slope, and number of driving lanes of one or more obstacles.

12. The method of claim 9, wherein the varying travel contexts comprise at least one of the group consisting of: traffic volume, weather, and time of day under which one or more obstacles are encountered.

13. The method of claim 9, wherein the destination is a first destination, and wherein the method further comprises:
identifying one or more obstacles along an initial driving route to a second destination specified by the user;
identifying features of each of the one or more obstacles and travel contexts under which the user is expected to encounter each of the one or more obstacles based on the initial driving route to the second destination;
applying the learning model using the identified features of each of the one or more obstacles and travel contexts, wherein the applying identifies at least one obstacle of the one or more obstacles along the initial driving route to the second destination that is to be avoided; and
recalculating the initial driving route to the second destination to provide an alternative driving route to the second destination, wherein the alternative route avoids the at least one obstacle along the initial driving route to the second destination.

14. A computer system comprising:
a memory; and
a processor in communication with the memory, wherein the computer system is configured to perform a method comprising:
identifying an obstacle along an initial driving route to a destination specified by a user;
presenting, on a user interface for the user, details of the obstacle;
prompting the user, on the user interface, to input, via the user interface, a rating for the obstacle that indicates the user's tolerance to traversing the obstacle while driving;
receiving from the user the rating for the obstacle, the rating indicating the user's tolerance to traversing the obstacle while driving, wherein the rating indicates that the obstacle is to be avoided; and
recalculating the initial driving route to the destination to provide an alternative driving route to the destination, wherein the alternative route avoids the obstacle.

15. The computer system of claim 14, wherein the presenting the details of the obstacle comprises presenting an image of the obstacle to the user on the user interface.

16. The computer system of claim 14, wherein the method further comprises:
extracting obstacle features of the obstacle;
identifying a travel context under which the user is expected to encounter the obstacle based on the initial driving route;
storing the extracted features and the travel context as an obstacle tolerance selection in a training database;
aggregating the obstacle tolerance selection with other obstacle tolerance selections in the training database, the other obstacle tolerance selections comprising other obstacle features and other travel contexts, wherein the aggregating provides training data; and
building and training a learning model, using the training data, to learn tolerances of the user as to traversing obstacles of varying obstacle features and in varying travel contexts.

17. The computer system of claim 16, wherein the destination is a first destination, and wherein the method further comprises:
identifying one or more obstacles along an initial driving route to a second destination specified by the user;
identifying features of each of the one or more obstacles and travel contexts under which the user is expected to encounter each of the one or more obstacles based on the initial driving route to the second destination;
applying the learning model using the identified features of each of the one or more obstacles and travel contexts, wherein the applying identifies at least one obstacle of the one or more obstacles along the initial driving route to the second destination that is to be avoided; and
recalculating the initial driving route to the second destination to provide an alternative driving route to the second destination, wherein the alternative route avoids the at least one obstacle along the initial driving route to the second destination.

18. A computer program product comprising:
a computer readable storage medium readable by a processing circuit and storing instructions for execution by the processing circuit to:
identify an obstacle along an initial driving route to a destination specified by a user;
present, on a user interface for the user, details of the obstacle;
prompt the user, on the user interface, to input, via the user interface, a rating for the obstacle that indicates the user's tolerance to traversing the obstacle while driving;
receive from the user the rating for the obstacle, the rating indicating the user's tolerance to traversing the obstacle while driving, wherein the rating indicates that the obstacle is to be avoided; and
recalculate the initial driving route to the destination to provide an alternative driving route to the destination, wherein the alternative route avoids the obstacle.

19. The computer program product of claim 18, wherein the stored instructions are further for execution by the processing circuit to:
extract obstacle features of the obstacle;
identify a travel context under which the user is expected to encounter the obstacle based on the initial driving route;
store the extracted features and the travel context as an obstacle tolerance selection in a training database;
aggregate the obstacle tolerance selection with other obstacle tolerance selections in the training database, the other obstacle tolerance selections comprising other obstacle features and other travel contexts, wherein the aggregating provides training data; and
build and train a learning model, using the training data, to learn tolerances of the user as to traversing obstacles of varying obstacle features and in varying travel contexts.

20. The computer program product of claim 19, wherein the destination is a first destination, and wherein the stored instructions are further for execution by the processing circuit to:
identify one or more obstacles along an initial driving route to a second destination specified by the user;
identify features of each of the one or more obstacles and travel contexts under which the user is expected to encounter each of the one or more obstacles based on the initial driving route to the second destination;
apply the learning model using the identified features of each of the one or more obstacles and travel contexts, wherein the applying identifies at least one obstacle of the one or more obstacles along the initial driving route to the second destination that is to be avoided; and
recalculate the initial driving route to the second destination to provide an alternative driving route to the second destination, wherein the alternative route avoids the at least one obstacle along the initial driving route to the second destination.
